(19) United States
(12) Patent Application Publication
(10) Pub. No.: US 2010/0142964 A1
(43) Pub. Date: Jun. 10, 2010

(54) OPTICAL TRANSMISSION APPARATUS WITH STABLE OPTICAL SIGNAL OUTPUT

(76) Inventors: Sun-hyok Chang, Daejeon-si (KR); Hwan-seok Chung, Daejeon-si (KR); Sang-soo Lee, Daejeon-si (KR); Kwang-joon Kim, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/581,797

(22) Filed: Oct. 19, 2009

(30) Foreign Application Priority Data
Dec. 8, 2008 (KR) 10-2008-0124166
Apr. 14, 2009 (KR) 10-2009-0032189

(51) Int. Cl. H04B 10/04; H04B 10/00; H04B 10/12

(52) U.S. Cl. 398/116; 398/192; 398/188

(57) ABSTRACT

An optical transmission apparatus for high-speed optical signal transmission is provided. The optical transmission apparatus includes an optical modulator which includes first and second modulators of a Mach-Zehnder (MZ) interferometer type which are connected in parallel, and an output stabilizer which controls biases for the first modulator, the second modulator and the optical modulator and stabilizes a final output optical signal of the optical modulator. The optical transmission apparatus can perform a stable optical signal output.

### CROSS-REFERENCE TO RELATED APPLICATIONS

This application claims the benefit under 35 U.S.C. §119(a) of Korean Patent Application Nos. 10-2008-0124166, filed on Dec. 8, 2008, and 10-2009-0032189, filed on Apr. 14, 2009, the disclosures of both of which are incorporated herein in their entirety by reference for all purposes.

### BACKGROUND

1. Field

The following description relates to an optical transmission apparatus for high-speed optical signal transmission, and more particularly, to an optical transmission apparatus using a phase shift keying technique.

2. Description of the Related Art

Wavelength division multiplexing (WDM) is an optical transmission technique which substantially increases the transmission capacity of optical transmission networks. In the WDM technique, a plurality of wavelength channels are transmitted through one optical fiber. For example, if one wavelength channel has a transmission rate of 10 Gb/s, when 50 wavelengths are transmitted at the same time, a transmission rate is 500 Gb/s. Therefore, the WDM is a very useful technique for high capacity transmission.

A time division multiplexing (TDM) optical transmission technique has also been rapidly developed, and an optical transceiving apparatus with a transmission rate of 40 Gb/s has been recently developed and commercialized. Research on an optical transceiving apparatus with a transmission rate of 100 Gb/s is actively under way.

However, in order to realize a high speed transmission rate, although high speed electrical devices have to be developed and commercialized, development of high speed electrical devices is still in an initial stage. Research on multi-level modulation techniques such as quadrature phase shift keying (QPSK) for realizing a transmission rate of 100 Gb/s is actively under way. In the QPSK, the transmission capacity of 100 Gb/s can be transmitted at a symbol rate of 50 GSymbol/s. Further, in a polarization-multiplexed (PM) QPSK technique, the transmission capacity of 100 Gb/s can be transmitted at a symbol rate of 25 GSymbol/s. That is, in the QPSK technique, 2 bits can be transmitted for each symbol, and in the PM-QPSK technique, 4 bits can be transmitted for each symbol. Therefore, the multi-level modulation techniques greatly reduce the demand on a transmission rate of high speed electrical devices.

### SUMMARY

The following description relates to an optical transmission apparatus with a stable optical signal output.

According to an exemplary aspect, there is provided an optical transmission apparatus, including: an optical modulator which includes first and second modulators of a Mach-Zehnder (MZ) interferometer type which are connected in parallel; and an output stabilizer which controls biases for the first modulator, the second modulator and the optical modulator and stabilizes a final output optical signal of the optical modulator.

The output stabilizer may include an optical detector which converts an optical signal which is output from the optical modulator and then split into an electrical signal, and a bias controller which applies bias dithering signals having different frequencies to the first modulator, the second modulator and the optical modulator, detects voltages corresponding to frequencies of the bias dithering signals from the converted electrical signal and controls biases such that the voltages are minimized.

The output stabilizer may include an optical detector including a first detector which converts an optical signal output from the first modulator into an electrical signal, a second detector which converts an optical signal output from the second modulator into an electrical signal, and a third detector which converts an optical signal output from the optical modulator into an electrical signal, and a bias controller which applies bias dithering signals with different frequencies to the first modulator, the second modulator, and the optical modulator, detects voltages corresponding to the frequencies of the bias dithering signals from the electrical signals converted through the first detector, the second detector, and the third detector, and controls biases such that the voltages are minimized.

The output stabilizer may include first and second splitters which split an optical signal output from the optical modulator, an optical detector including a first detector which converts the optical signal split through the first splitter into an electrical signal and a second detector which converts the optical signal split through the second splitter into an electrical signal, and a bias controller which applies bias dithering signals with different frequencies to the first modulator, the second modulator, and the optical modulator, detects a voltage corresponding to a frequency of the bias dithering signal applied to the optical modulator from the electrical signal converted through the first detector, and controls bias such that the voltage is minimized, and detects voltages corresponding to the frequencies of the bias dithering signals applied to the first and second modulators from the electrical signal converted through the second detector and controls biases such that the voltages are minimized.

Other objects, features and advantages will be apparent from the following description, the drawings, and the claims.

### BRIEF DESCRIPTION OF THE DRAWINGS

FIG. 1 is a configuration diagram of a binary phase shift keying (BPSK) optical transmission apparatus;

FIG. 2 is a diagram for explaining the principle of a BPSK optical modulator and bias dithering;

FIG. 3 is a configuration diagram of a QPSK optical transmission apparatus;

FIG. 4 is a diagram illustrating an output constellation of an ideal QPSK optical modulator;

FIG. 5 is a diagram illustrating an output constellation of a non-ideal QPSK optical modulator;

FIG. 6 is a configuration diagram of a QPSK optical transmission apparatus according to a first exemplary embodiment;

FIG. 7 is a configuration diagram of a QPSK optical transmission apparatus according to a second exemplary embodiment;

FIG. 8 is a configuration diagram of a QPSK optical transmission apparatus according to a third exemplary embodiment;

FIG. 9 is a configuration diagram of a QPSK optical transmission apparatus according to a fourth exemplary embodiment;

FIG. 10 is a configuration diagram of a QPSK optical transmission apparatus according to a fifth exemplary embodiment;

FIG. 11 is a diagram illustrating a first example of a π/4 optical hybrid; and

FIG. 12 is a diagram illustrating a second example of a π/4 optical hybrid.

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

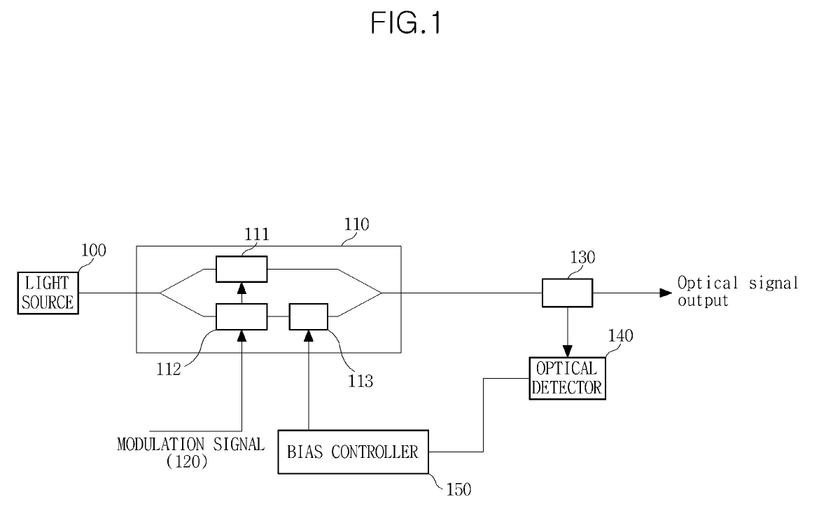

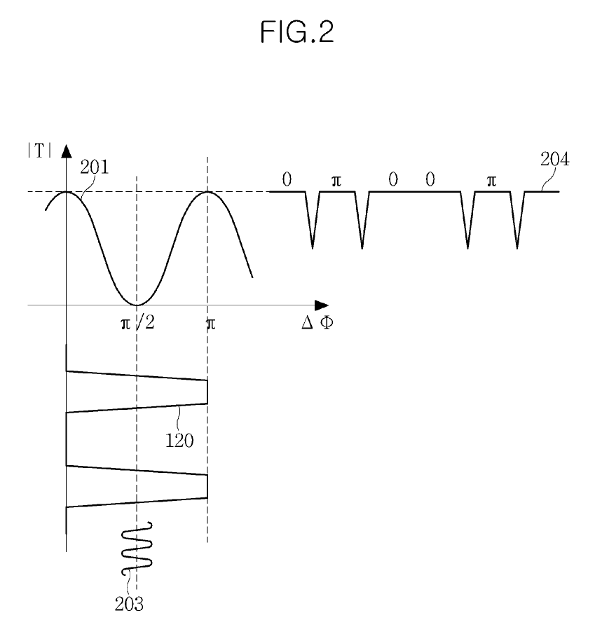

FIG. 1 is a configuration diagram of a binary phase shift keying (BPSK) optical transmission apparatus, and FIG. 2 is a diagram for explaining the principle of a BPSK optical modulator and bias dithering.

A light source 100 is configured to output an optical signal and may include a laser diode (LD). A BPSK modulator 110 receives the optical signal output from the light source 100, modulates the optical signal using a BPSK technique and outputs the modulated optical signal. The BPSK is one of phase shift keying (PSK) techniques, and the BPSK modulator 110 is commonly realized by an amplitude modulator of a Mach-Zehnder (MZ) interferometer type. The BPSK modulator 110 includes two MZ modulators 111 and 112 which are connected in parallel and a phase shifter 113 which shifts a phase of an output of the lower MZ modulator 112.

An output of the amplitude modulator of the MZ interferometer type has a transmittance T 201 of 0.5 (1+cos ΔØ) with respect to a phase difference ΔØ between two arms of an interferometer. The transmittance T has a value of “1” when ΔØ has values of 0 and π. A modulation signal 120 which is generated by a precoder and applied to the upper MZ modulator 111 and the lower MZ modulator 112 is used to modulate a phase of an input optical signal as in reference numeral 201 in FIG. 2, and an output of the BPSK modulator 110 is represented by reference numeral 204. When an amplitude of the modulation signal 120 is determined so that a phase difference modulated by the modulation signal 120 can be π, optical power of the output 204 is constant, but a phase has values of 0 and π. Therefore, an optical output is a phase-modulated signal, that is, a BPSK signal.

Here, it can be understood that a phase difference ΔØ has to be π/2. However, since a bias value for actually generating the phase difference ΔØ may shift left and right (DC-bias drift) according to time, the bias value needs to be controlled. For bias control, a bias controller 150 applies a bias dithering signal 203 to the phase shifter 113. Here, let us assume a frequency of the bias dithering signal is “f,” and the frequency f of the bias dithering signal has a very small value compared to a frequency of the modulation signal 120. It can be understood in FIG. 2 that when bias of ΔØ matches with π/2, a 2*f frequency component of an optical output increases, and a 1*f frequency component decreases. It can be also understood that as bias of ΔØ deviates from π/2, the 2*f frequency component decreases, and the 1*f frequency component increases. A bias value is controlled such that part of an optical signal split by a splitter 130 of FIG. 1 is detected through a photo-detector (PD) 140, and the 1*f or 2*f frequency component is measured through the bias controller 150. In this manner, bias for generating π/2 which is a stable phase difference can be obtained.

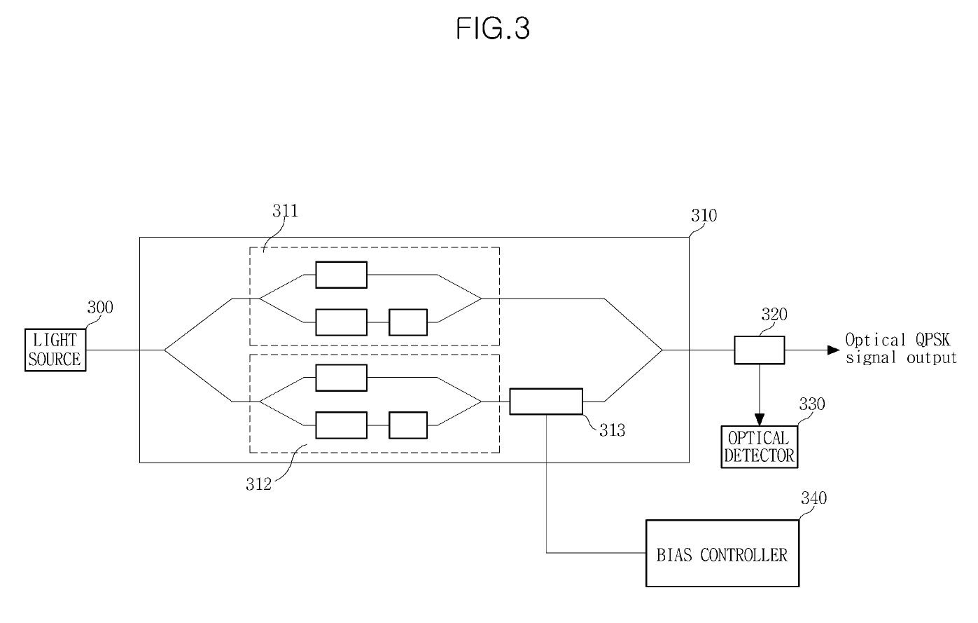

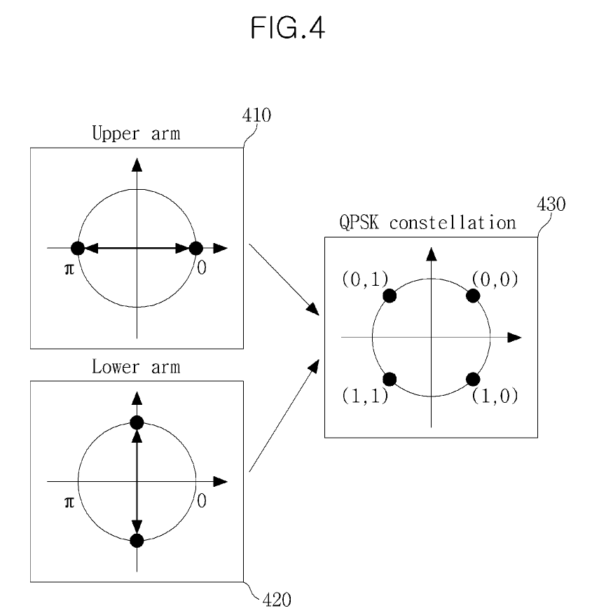

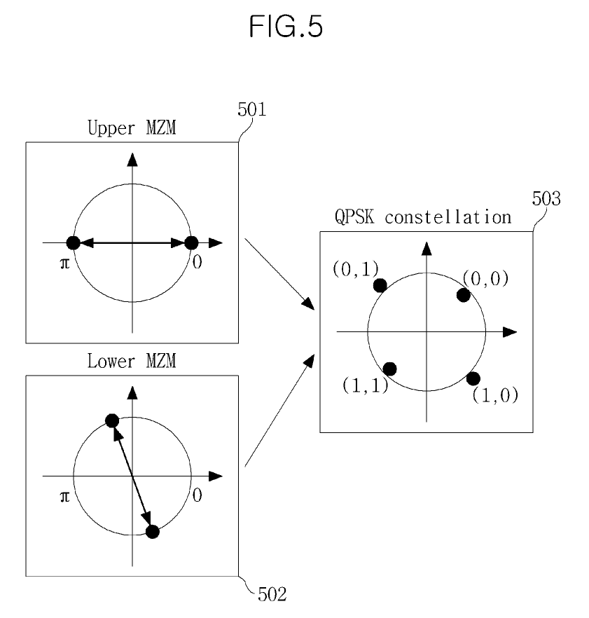

FIG. 3 is a configuration diagram of a QPSK optical transmission apparatus, FIG. 4 is a diagram illustrating an output constellation of an ideal QPSK optical modulator, and FIG. 5 is a diagram illustrating an output constellation of a non-ideal QPSK optical modulator.

A QPSK optical modulator 310 receives an optical signal output from a light source 300, modulates the optical signal using a quadrature phase shift keying (QPSK) technique and outputs the modulated optical signal. The QPSK optical modulator 310 includes first and second modulators 311 and 312 which are two MZ modulators which are connected in parallel and a phase shifter 313 which is serially connected to an output of the second modulator 312 as illustrated in FIG. 3. The first and second modulators 311 and 312 are identical in configuration to the BPSK modulator 110 of FIG. 1 and operate on the same principle as in FIG. 2.

In FIG. 4, an x axis denotes an x component of an optical output electric field, and a y axis denotes a y component of the optical output electric field. An output of the first modulator 311 of FIG. 3 has a constellation corresponding to an upper arm 410 of FIG. 4, and an output of the second modulator 312 of FIG. 3 also has a constellation corresponding to the upper arm 410 of FIG. 4. A phase shift of π/2 is made through the phase shifter 313 of FIG. 3, so that an output of the second modulator 312 has a constellation corresponding to a lower arm 420 of FIG. 4. Consequently, an output of the upper arm 410 and an output of the lower arm 420 are added to generate a QPSK optical signal such as reference numeral 430 of FIG. 4.

However, when a phase difference between the upper arm 410 and the lower arm 420, that is, a phase difference through the phase shifter 313, deviates from π/2, the QPSK signal deviates from an ideal state. Since a lower arm 520 of FIG. 5 does not match with π/2, when an upper arm 510 and the lower arm 520 are added, a constellation in which an amplitude is not constant as in reference numeral 530 of FIG. 5 is generated. This strongly affects a characteristic of the QPSK optical signal. Therefore, in this case, bias control for maintaining a π/2 phase difference is needed. To this end, as illustrated in FIG. 3, the splitter 320 partially splits an output optical signal of the QPSK modulator 310, the split optical signal is detected through an optical detector 330, and bias is adjusted through a bias controller 340, whereby a π/2 phase difference is obtained.

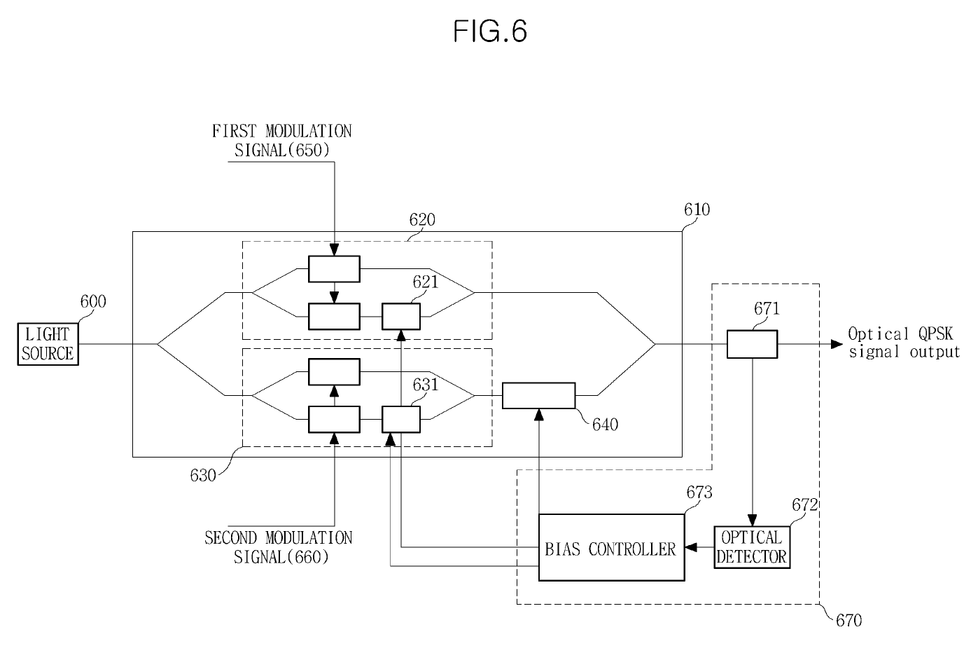

FIG. 6 is a configuration diagram of a QPSK optical transmission apparatus according to a first exemplary embodiment.

A light source 600 is configured to output an optical signal and may include a laser diode (LD). An optical modulator 610 functions as a photo detector, and is a QPSK modulator which receives the optical signal output from the light source 600, modulates the optical signal using a QPSK technique and outputs the modulated optical signal. The QPSK modulator 610 includes first and second modulators 620 and 630 which are two MZ modulators which are connected in parallel and a phase shifter 640 which is serially connected to an output of the second modulator 630. The first and second modulators 620 and 630 are BPSK modulators. A first modulation signal 650 applied to the first modulator 620 and a second modulation signal 660 applied to the second modulator 630 are signals which are input for optical signal modulation of the first modulator 620 and the second modulator 630, respectively, and are signals which are generated and output through a precoder as is already well known.

An output stabilizer 670 includes a splitter 671, an optical detector 672, and a bias controller 673. The splitter 671 is disposed on an output line of the optical modulator 610 and splits an output optical signal to the optical detector 672. The optical detector 672 receives the optical signal split through the splitter 671, converts the split optical signal into an electrical signal and outputs the electrical signal to the bias controller 673. The bias controller 673 controls bias values which are applied to first and second phase shifter 621 and 631 of the first modulator 620 and the third phase shifter 640 of the optical modulator 610.

Bias control of the bias controller 673 will be described below in detail. The bias controller 673 applies dithering signals with different frequencies to the phase shifters 621, 631, and 540 of the modulators. Let us assume that a frequency of a bias dithering signal applied to the first phase shifter 621 is f1, a frequency of a bias dithering signal applied to the second phase shifter 621 is f2, and a frequency of a bias dithering signal applied to the third phase shifter 640 is f3. In this case, amplitudes of the bias dithering signals have to be much smaller than a modulation amplitude of the optical modulator 610, and f1, f2 and f3 has to be much smaller than a symbol rate of the output optical signal.

The optical signal is partially split through the splitter 671, and then the split optical signal is detected through the optical detector 672. A bandwidth of the optical detector 672 has to be much lower than a symbol rate and larger than values of f1, f2, and f3. An output of the optical detector 672 is input to the bias controller 673, and the bias controller 673 detects voltage values corresponding to frequencies f1, f2, and f3 and then adjusts biases applied to the phase shifters 621, 631, and 640 such that the voltage values are minimized. In this manner, biases of the modulators can be adjusted, and as biases are stabilized, a stable QPSK optical output can be obtained.

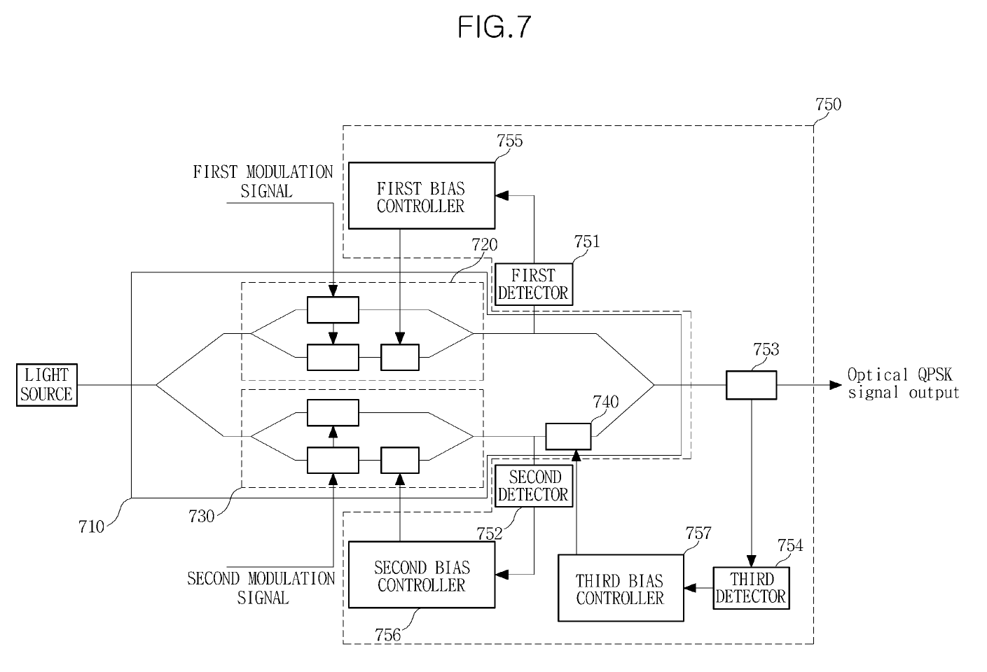

FIG. 7 is a configuration diagram of a QPSK optical transmission apparatus according to a second exemplary embodiment.

The QPSK optical transmission apparatus of FIG. 7 is different in configuration of an output stabilizer 750 from the QPSK optical transmission apparatus of FIG. 6. The output stabilizer 750 of FIG. 7 is configured to detect an optical signal and includes a first detector 751 which receives an optical signal split from an output of a first modulator 720, a second detector 752 which receives an optical signal split from an output of a second modulator 730, and a third detector 754 which receives an optical signal split from an output of an optical modulator 710 through a splitter 753. A configuration of a bias controller which controls bias may be logically or physically divided into a first bias controller 755, a second bias controller 756, and a third bias controller 757.

The first bias controller 755 applies a bias dithering signal with an f1 frequency to an upper MZ modulator, that is, a first modulator 720. The output is detected through the first detector 751, and the first bias controller 755 receives the detected signal to detect a voltage value corresponding to the f1 frequency and adjusts bias such that the detected voltage value is minimized. The second bias controller 756 applies a bias dithering signal with an f2 frequency to a lower MZ modulator, that is, a second modulator 730. The output is detected through the second detector 752, and the second bias controller 756 receives the detected signal to detect a voltage value corresponding to the f2 frequency and adjusts bias such that the detected voltage value is minimized. The third bias controller 757 applies a bias dithering signal with an f3 frequency to a lower arm, that is, a phase shifter 740 of the optical modulator 710. The output is detected through the third detector 754, and the third bias controller 757 receives the detected signal to detect a voltage value corresponding to the f3 frequency and adjusts bias such that the detected voltage value is minimized. It can be understood that a bias control method is identical to that described with reference to FIG. 6.

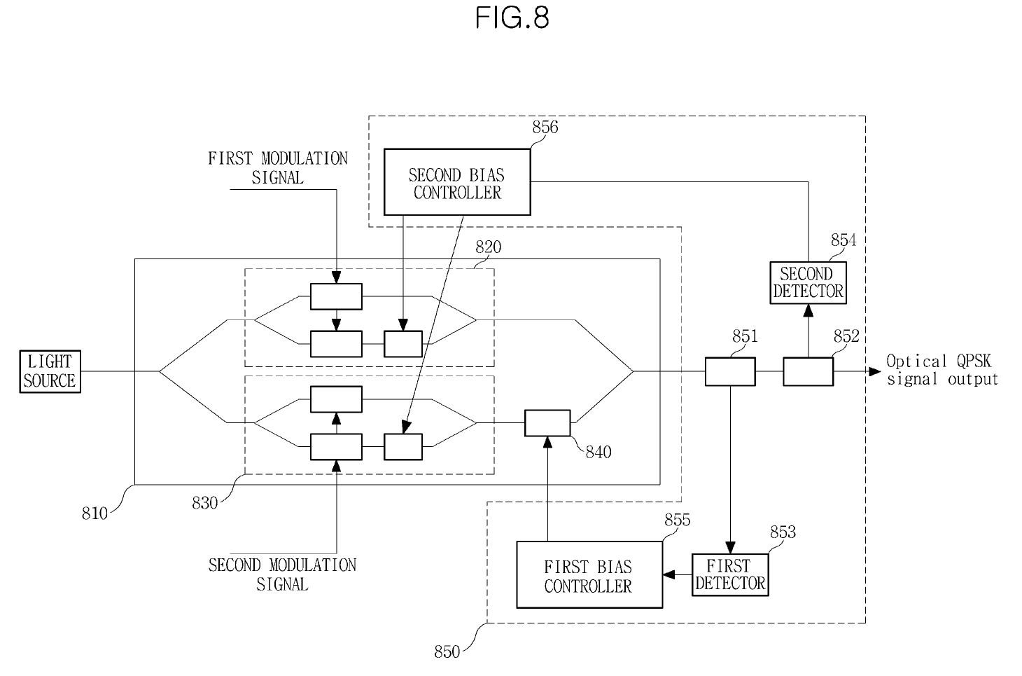

FIG. 8 is a configuration diagram of a QPSK optical transmission apparatus according to a third exemplary embodiment.

An output stabilizer 850 includes first and second splitters 851 and 852 and first and second detectors 853 and 854. A bias controller is logically or physically divided into a first bias controller 855 and a second bias controller 856. The first detector 853 detects an optical signal which is output from an optical modulator 810 and split through the first splitter 851, and the second detector 854 detects an optical signal which is output from an optical modulator 810 and split through the second splitter 852. The first bias controller 855 applies a bias dithering signal with an f3 frequency to a phase shifter 840 of the optical modulator 810, detects a voltage value corresponding to the f3 frequency of the signal detected by the first detector 853, and adjusts bias applied to the phase shifter 840 so that the detected voltage value can be minimum. The second bias controller 856 applies a bias dithering signal with an f1 frequency to the first modulator 810 and a bias dithering signal with an f2 frequency to the second modulator 830. The second bias controller 856 detects voltage values corresponding to the f2 frequency and the f3 frequency of the signal detected by the second detector 854, and adjusts biases applied to the first and second modulators 820 and 830 such that the detected voltage values are minimized.

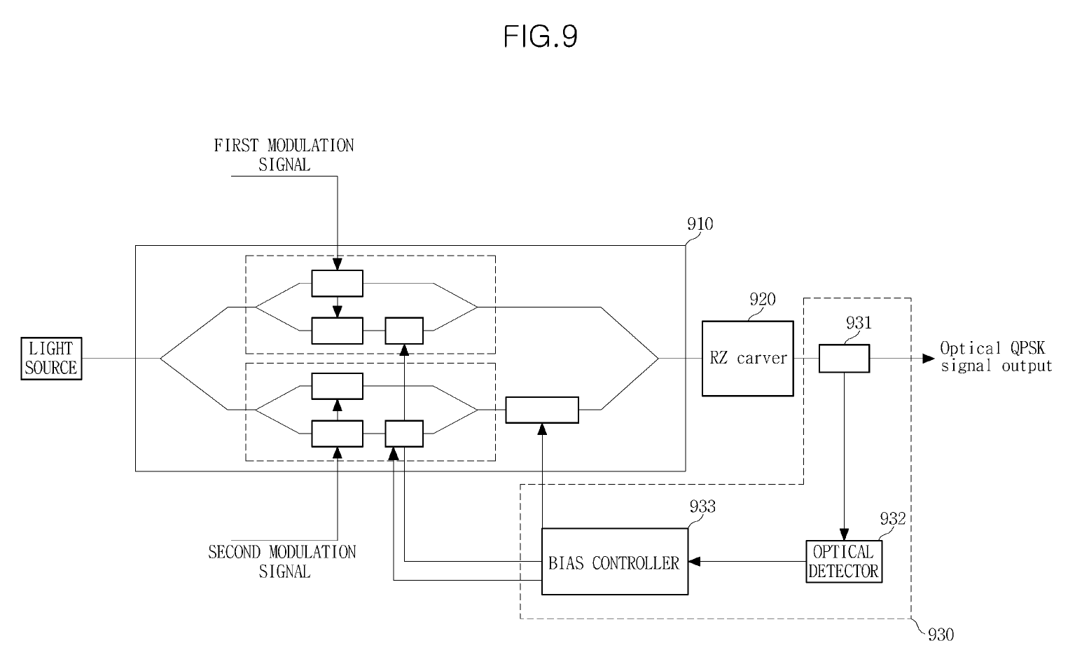

FIG. 9 is a configuration diagram of a QPSK optical transmission apparatus according to a fourth exemplary embodiment.

A return-to-zero (RZ) carver 920 may be connected to an output line of a QPSK optical modulator 910 to generate a RZ-QPSK modulated optical signal. The RZ-QPSK modulated optical signal has many advantages from the point of view of transmission compared to a QPSK-modulated optical signal. A splitter 931 splits the RZ-QPSK modulated optical signal, and an optical detector 932 converts the split optical signal into an electrical signal and outputs the electrical signal. The bias controller 933 controls bias based on the electrical signal. A bias control method is identical to that described with reference to FIG. 6. A configuration in which the RZ carver is added may be applied to FIGS. 7, 8, and 9.

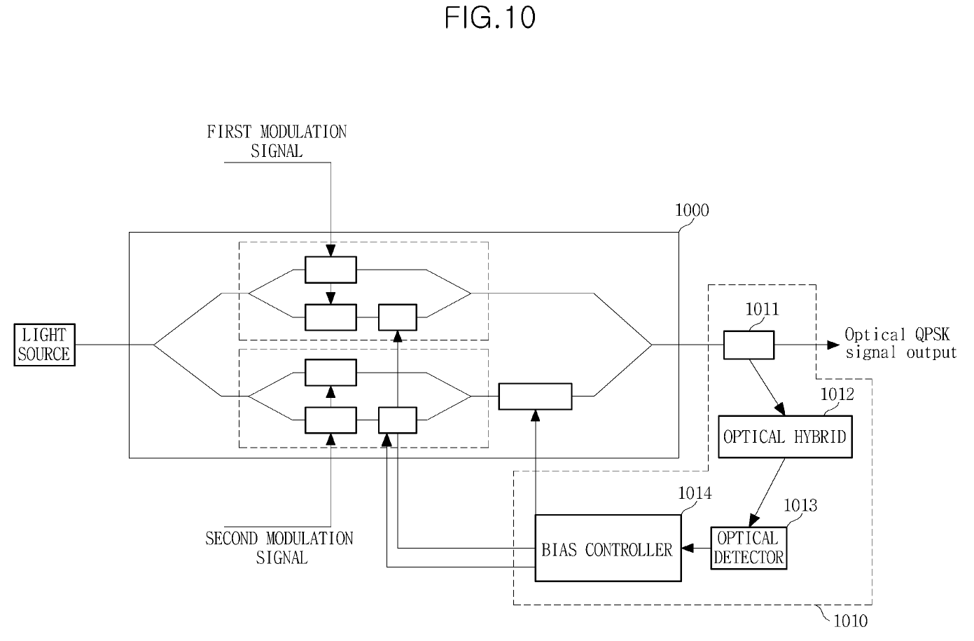

FIG. 10 is a configuration diagram of a QPSK optical transmission apparatus according to a fifth exemplary embodiment.

It can be understood that a configuration of a π/4 optical hybrid 1012 is added to the configuration of FIG. 6. An output of the QPSK optical modulator 1000 is split through a splitter 1011 of an output stabilizer 1010, and the split signal passes through the π/4 optical hybrid 1012 and is converted into an electrical signal through an optical detector 1013, and the electrical signal is input to a bias controller 1014. In the case in which the π/4 optical hybrid 1012 is used, a larger signal can be obtained. This configuration may be applied to FIGS. 7, 8, and 9.

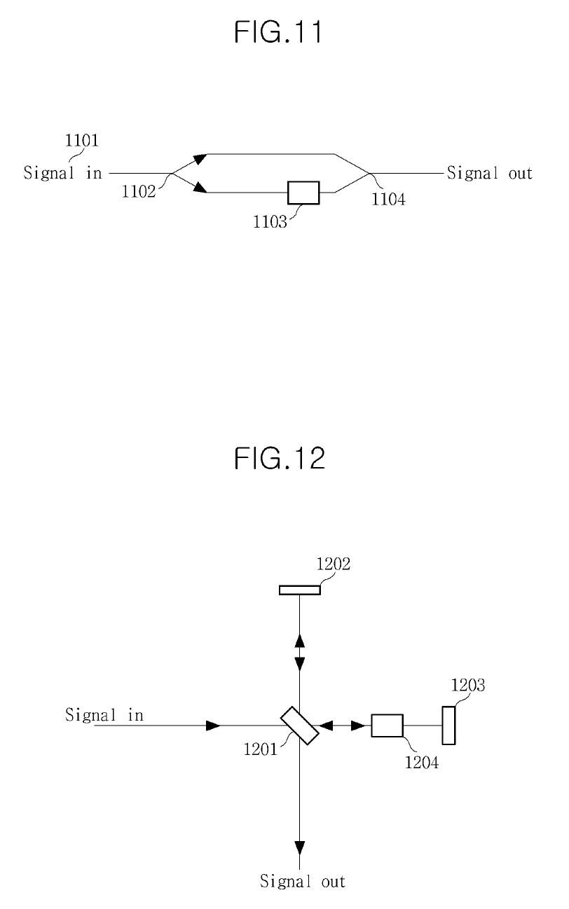

FIG. 11 is a diagram illustrating a first example of a π/4 optical hybrid, and FIG. 12 is a diagram illustrating a second example of a π/4 optical hybrid.

FIG. 11 illustrates a Mach-Zehnder (MZ) type interferometer, and FIG. 12 illustrates a Michelson type interferometer. In FIG. 11, an input optical signal 1101 is split into two at reference numeral 1102 and added again at reference numeral 1104. A light phase difference between a lower path and an upper path is adjusted or fixed to π/4 at reference numeral 1103. In FIG. 12, an input optical signal is split into two through a beam splitter 1201, and the split signals are reflected from reflection mirrors 1202 and 1203 and added through the beam splitter 1201 again. A phase difference between two light paths is adjusted or fixed to π/4 at reference numeral 1204.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

As apparent from the above description, a phase difference between two MZ modulators of a QPSK optical modulator and a phase difference between two arms can be simultaneously controlled. Therefore, a stable QPSK-modulated optical output can be obtained.

It will be apparent to those of ordinary skill in the art that various modifications can be is made to the exemplary embodiments of the invention described above. However, as long as modifications fall within the scope of the appended claims and their equivalents, they should not be misconstrued as a departure from the scope of the invention itself.

What is claimed is:

1. An optical transmission apparatus, comprising:
an optical modulator which includes first and second modulators of a Mach-Zehnder (MZ) interferometer type which are connected in parallel; and
an output stabilizer which controls biases for the first modulator, the second modulator and the optical modulator and stabilizes a final output optical signal of the optical modulator.

2. The optical transmission apparatus of claim 1, wherein the output stabilizer comprises:
an optical detector which converts an optical signal which is output from the optical modulator and then split into an electrical signal; and
a bias controller which applies bias dithering signals having different frequencies to the first modulator, the second modulator and the optical modulator, detects voltages corresponding to frequencies of the bias dithering signals from the converted electrical signal and controls biases such that the voltages are minimized.

3. The optical transmission apparatus of claim 2, wherein a bandwidth of the optical detector is lower than an output symbol rate of the optical modulator and larger than the frequencies of the bias dithering signals.

4. The optical transmission apparatus of claim 2, wherein the output stabilizer further comprises an optical hybrid which receives an optical signal which is output from the optical modulator and then split and outputs the optical signal to the optical detector.

5. The optical transmission apparatus of claim 2, wherein the first and second modulators are binary phase shift keying (BPSK) modulators, and the optical modulator is a quadrature phase shift keying (QPSK) modulator.

6. The optical transmission apparatus of claim 5, further comprising a return-to-zero (RZ) carver which is serially connected to an output of the optical modulator.

7. The optical transmission apparatus of claim 1, wherein the output stabilizer comprises:
an optical detector including a first detector which converts an optical signal output from the first modulator into an electrical signal, a second detector which converts an optical signal output from the second modulator into an electrical signal, and a third detector which converts an optical signal output from the optical modulator into an electrical signal; and
a bias controller which applies bias dithering signals with different frequencies to the first modulator, the second modulator, and the optical modulator, detects voltages corresponding to the frequencies of the bias dithering signals from the electrical signals converted through the first detector, the second detector, and the third detector, and controls biases such that the voltages are minimized.

8. The optical transmission apparatus of claim 7, wherein a bandwidth of the optical detector is lower than an output symbol rate of the optical modulator and larger than frequencies of the bias dithering signals.

9. The optical transmission apparatus of claim 7, wherein the output stabilizer further comprises an optical hybrid which receives an optical signal which is output from the optical modulator and then split and outputs the optical signal to the third detector.

10. The optical transmission apparatus of claim 7, wherein the output stabilizer further comprises an optical hybrid which receives an optical signal which is output from the first modulator and then split and outputs the optical signal to the first detector.

11. The optical transmission apparatus of claim 7, wherein the output stabilizer further comprises an optical hybrid which receives an optical signal which is output from the second modulator and then split and outputs the optical signal to the second detector.

12. The optical transmission apparatus of claim 7, wherein the first and second modulators are binary phase shift keying (BPSK) modulators, and the optical modulator is a quadrature phase shift keying (QPSK) modulator.

13. The optical transmission apparatus of claim 12, further comprising a return-to-zero (RZ) carver which is serially connected to an output of the optical modulator.

14. The optical transmission apparatus of claim 1, wherein the output stabilizer comprises:
a first splitter and a second splitter which split an optical signal output from the optical modulator;
an optical detector including a first detector which converts the optical signal split through the first splitter into an electrical signal and a second detector which converts the optical signal split through the second splitter into an electrical signal; and
a bias controller which applies bias dithering signals with different frequencies to the first modulator, the second modulator, and the optical modulator, detects a voltage corresponding to a frequency of the bias dithering signal applied to the optical modulator from the electrical signal converted through the first detector, and controls bias such that the voltage is minimized, and detects voltages corresponding to the frequencies of the bias dithering signals applied to the first and second modulators from the electrical signal converted through the second detector and controls biases such that the voltages are minimized.

15. The optical transmission apparatus of claim 14, wherein a bandwidth of the optical detector is lower than an output symbol rate of the optical modulator and larger than frequencies of the bias dithering signals.

16. The optical transmission apparatus of claim 14, wherein the output stabilizer further comprises an optical hybrid which receives the optical signal split through the first splitter and outputs the optical signal to the optical detector.

17. The optical transmission apparatus of claim 14, wherein the output stabilizer further comprises an optical hybrid which receives the optical signal split through the second splitter and outputs the optical signal to the optical detector.

18. The optical transmission apparatus of claim 14, wherein the first and second modulators are binary phase shift keying (BPSK) modulators, and the optical modulator is a quadrature phase shift keying (QPSK) modulator.

19. The optical transmission apparatus of claim 18, further comprising a return-to-zero (RZ) carver which is serially connected to an output of the optical modulator.
